(19) United States
(12) Patent Application Publication
(10) Pub. No.: US 2003/0076259 A1
(43) Pub. Date: Apr. 24, 2003

(54) ANTENNA APPARATUS HAVING CROSS-SHAPED SLOT

(75) Inventor: Xin Zhang, Ibaraki (JP)

Correspondence Address: FOLEY AND LARDNER, SUITE 500, 3000 K STREET NW, WASHINGTON, DC, 20007, US

(73) Assignee: HITACHI CABLE, LTD

(21) Appl. No.: 09/981,787

(22) Filed: Oct. 19, 2001

(51) Int. Cl. H01Q 1/38; H01Q 13/10

(52) U.S. Cl. 343/700 MS; 343/770; 343/767

(57) ABSTRACT

A primary object of the present invention is to provide a small and highly efficient antenna apparatus having a polarization diversity function with a plurality of antenna elements. A secondary object of the present invention is to provide an antenna apparatus having a broadband property. By feeding power to two radiation area 5b perpendicular to each other of a cross-shaped slot 4 formed on a conductive plate 3, polarization diversity is performed. By forming a plurality of such cross-shaped slots 4 in one line on one conductive plate 3a, attaching a crossing area potential-relaxing conductive part 5a on the backside of a crossing 4a of each slot 4 on the dielectric substrate 3a and attaching a radiation area potential-relaxing conductive parts 5b on the backside of a radiation area 4b of each slot 4, a small and highly efficient antenna apparatus can be obtained. Also by providing an electric characteristics adjusting plate 17 on one face of the dielectric, an antenna apparatus having a broadband property can be obtained.

### BACKGROUND OF THE INVENTION

1. Field of the Invention

The present invention relates to an antenna apparatus, and morespecifically, relates to an antenna apparatus in which an antenna element comprising a conductive plate having a slot formed thereon is attached to a dielectric substrate.

2. Prior Art

There is an antenna apparatus having an antenna element having a straight-line notch (hereinafter referred to as a “slot”) formed on a conductive plate attached to a dielectric substrate (hereinafter referred to as a “slot antenna”). By feeding power to the slot of this antenna apparatus from a high frequency power source, the electromagnetic field resonates in the slot to thereby radiate radio wave. This kind of slot antenna has excellent electric characteristics, and hence is used in a wide range of application.

The above-described slot antenna, however, is suitable for being used as a single antenna, but it is difficult to use it as a polarization diversity antenna. It is also difficult to arrange a plurality of slot antennas, due to a restriction in the antenna size or the like. Moreover, by arranging a plurality of slot antennas on the space for one slot antenna, interference between antennas increases, and hence practical use of such an antenna has been difficult.

### SUMMARY OF THE INVENTION

It is therefore a primary object of the present invention to provide a small and highly efficient antenna apparatus having a polarization diversity function with a plurality of antenna elements. A secondary object of the present invention is to provide an antenna apparatus having a broadband property.

In order to achieve the above objects, a first aspect of the present invention provides an antenna apparatus in which an antenna element comprising a conductive plate having a slot formed thereon is attached to a dielectric substrate, wherein the antenna element comprises: a conductive plate attached to one face of the dielectric substrate and having a cross-shaped slot formed thereon; a crossing area potential-relaxing conductive part attached at the position of a crossing of the cross-shaped slot on the other face of the dielectric substrate; and a strip-shaped radiation area potential-relaxing conductive parts attached at the position of a radiation area of the cross-shaped slot on the other face of the dielectric substrate.

A second aspect of the present invention provides an antenna apparatus in which an antenna element comprising a conductive plate having a slot formed thereon is attached to a dielectric substrate, wherein the antenna element comprises: a conductive plate attached to one face of the dielectric substrate and having a plurality of cross-shaped slots formed thereon; a crossing area potential-relaxing conductive part attached at the position of each crossing of each cross-shaped slot on the other face of the dielectric substrate; and a strip-shaped radiation area potential-relaxing conductive parts attached at the position of each radiation area of each cross-shaped slot on the other face of the dielectric substrate.

In addition to the above construction, the antenna apparatus of the present invention is preferably such that a reflecting plate consisting of a conductor is provided on the other face of the dielectric substrate, via spacers in parallel thereto, so as to cover the dielectric substrate.

In addition to the above construction, the antenna apparatus of the present invention is preferably such that an electric characteristics adjusting plate consisting of a conductor is provided on one face of the dielectric substrate, via spacers in parallel to the dielectric, so as to cover the central portion of each cross-shaped slot.

In addition to the above construction, the antenna apparatus of the present invention may have a notch formed on the electric characteristics adjusting plate.

In addition to the above construction, the electric characteristics adjusting plate of the antenna apparatus of the present invention may comprise another dielectric substrate, a main non-feeding element attached on the other dielectric substrate, and a plurality of strip-shaped sub non-feeding element attached in parallel to an opposing side of the main non-feeding element on the other dielectric substrate.

In addition to the above construction, a notch may be formed on at least either one of the main non-feeding element or the sub non-feeding element of the antenna apparatus of the present invention.

In addition to the above construction, in the antenna apparatus of the present invention, it is desired that power is fed in parallel to the radiation area of each slot.

According to the present invention, by feeding power to two radiation areas perpendicular to each other of the cross-shaped slot formed on the conductive plate, polarization diversity is performed. By forming a plurality of such cross-shaped slots on the conductive plate, attaching the crossing area potential-relaxing conductive part on the backside of the crossing of each slot on the dielectric substrate and attaching the radiation area potential-relaxing conductive parts on the backside of the radiation area of each slot, a small and highly efficient antenna apparatus can be obtained. Also by providing the electric characteristics adjusting plate on one face of the dielectric, an antenna apparatus having a broadband property can be obtained.

According to the present invention, the following excellent effects can be exerted.

A plurality of antenna elements can realize a small and highly efficient antenna apparatus having a polarization diversity function, an antenna apparatus having a broadband property can be also provided.

### BRIEF DESCRIPTION OF THE DRAWINGS

FIG. 1 is an elevational view showing one embodiment of an antenna element used in the antenna apparatus of the present invention;

FIG. 2 is an exploded perspective view of the antenna element shown in FIG. 1;

FIG. 3 is an elevational view showing an antenna apparatus in which a feeder line is attached to the antenna element shown in FIG. 1;

FIG. 4 is an exploded perspective view of the antenna apparatus shown in FIG. 3;

FIG. 5 is an appearance perspective view showing the appearance in another embodiment of the antenna apparatus of the present invention;

FIG. 6 is an exploded perspective view showing another embodiment of the antenna apparatus of the present invention;

FIG. 7 is a appearance perspective view showing the appearance in another embodiment of the antenna apparatus of the present invention;

FIG. 8 is a appearance perspective view showing the appearance of a modified embodiment of the antenna apparatus of the present invention;

FIG. 9 is an exploded perspective view showing a modified embodiment of the antenna apparatus of the present invention;

FIG. 10 is an exploded perspective view showing a modified embodiment of the antenna apparatus of the present invention;

FIG. 11 is an exploded perspective view showing a modified embodiment of the antenna apparatus of the present invention;

FIG. 12 is an exploded perspective view showing a modified embodiment of the antenna apparatus of the present invention;

FIG. 13 is an exploded perspective view showing a modified embodiment of the antenna apparatus of the present invention;

FIG. 14 is an exploded perspective view showing a modified embodiment of the antenna apparatus of the present invention;

FIG. 15 is an exploded perspective view showing a modified embodiment of the antenna apparatus of the present invention;

FIG. 16 is an elevational view showing another embodiment of the antenna apparatus of the present invention;

FIG. 17 is a perspective view showing the appearance in another embodiment of the antenna apparatus of the present invention; and

FIG. 18 is a perspective view showing the appearance in another embodiment of the antenna apparatus of the present invention.

### DESCRIPTION OF THE PREFERRED EMBODIMENTS

Embodiments of the present invention will now be described in detail, with reference to the accompanying drawings.

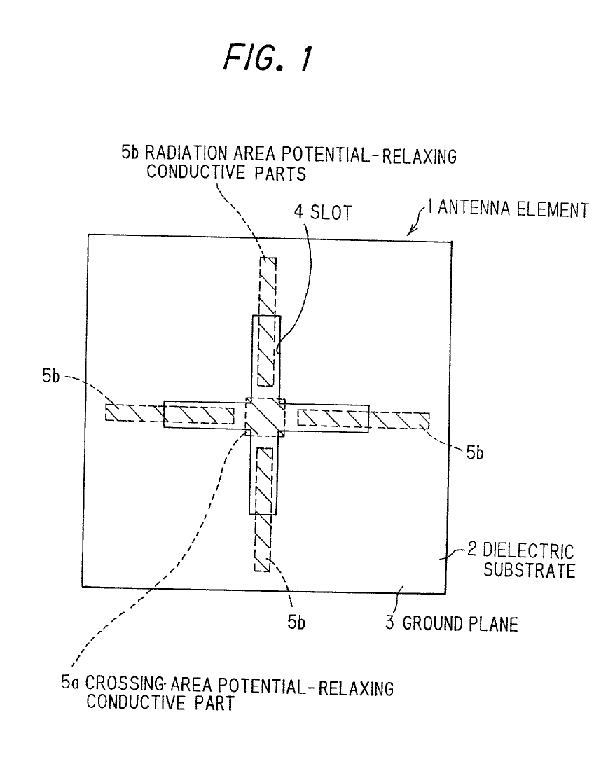

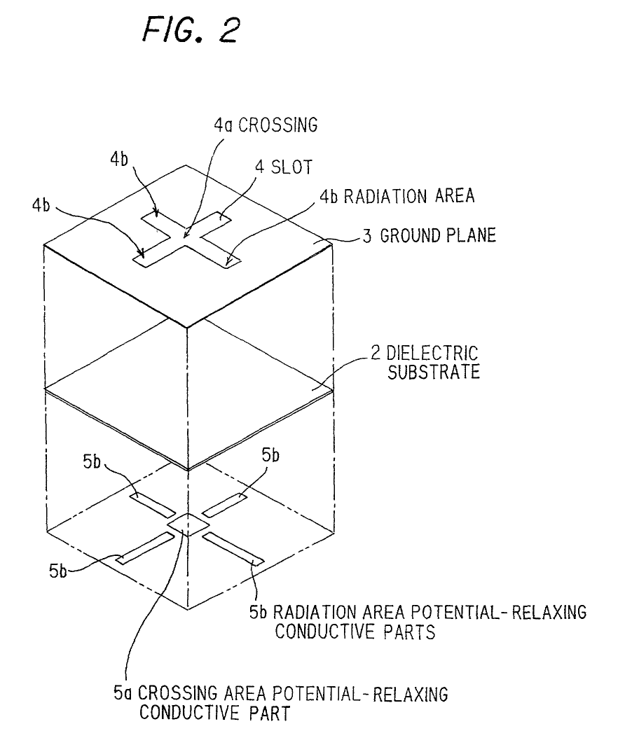

FIG. 1 is an elevational view showing one embodiment of an antenna element used in the antenna apparatus of the present invention. FIG. 2 is an exploded perspective view of the antenna element shown in FIG. 1.

The antenna element 1 is formed such that a conductive plate 3 having a cross-shaped slot 4 formed thereon is attached on one face (the upper face in FIG. 2) of a dielectric substrate 2, and a crossing area potential-relaxing conductive part 5a is attached on the other face of the dielectric substrate 2 (the lower face in FIG. 2), at the position of a crossing 4a of the cross-shaped slot 4, and a strip-shaped radiation area potential-relaxing conductive parts 5b is attached at the position of a radiation area 4b of the cross-shaped slot on the other face of the dielectric substrate 2.

This antenna element 1 is formed by using a printed circuit board in which a conductive plate (foil) 3 consisting of a copper plate or an aluminum plate is formed on the opposite faces of the dielectric substrate 2, forming a cross-shaped slot 4, for example, by a method of etching the conductive plate 3 on the one face, and leaving the crossing area potential-relaxing conductive part 5a and the radiation area potential-relaxing conductive parts 5b by a method of etching the other face thereof.

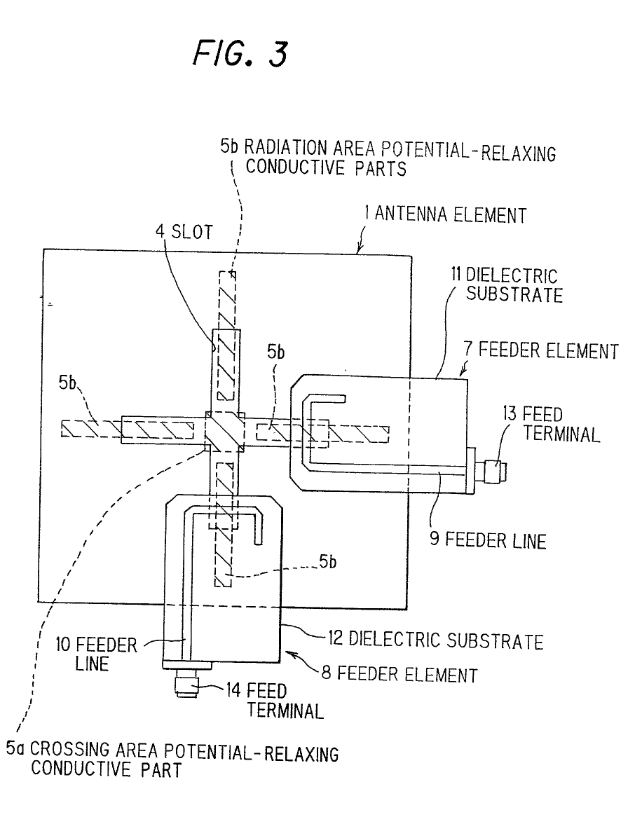

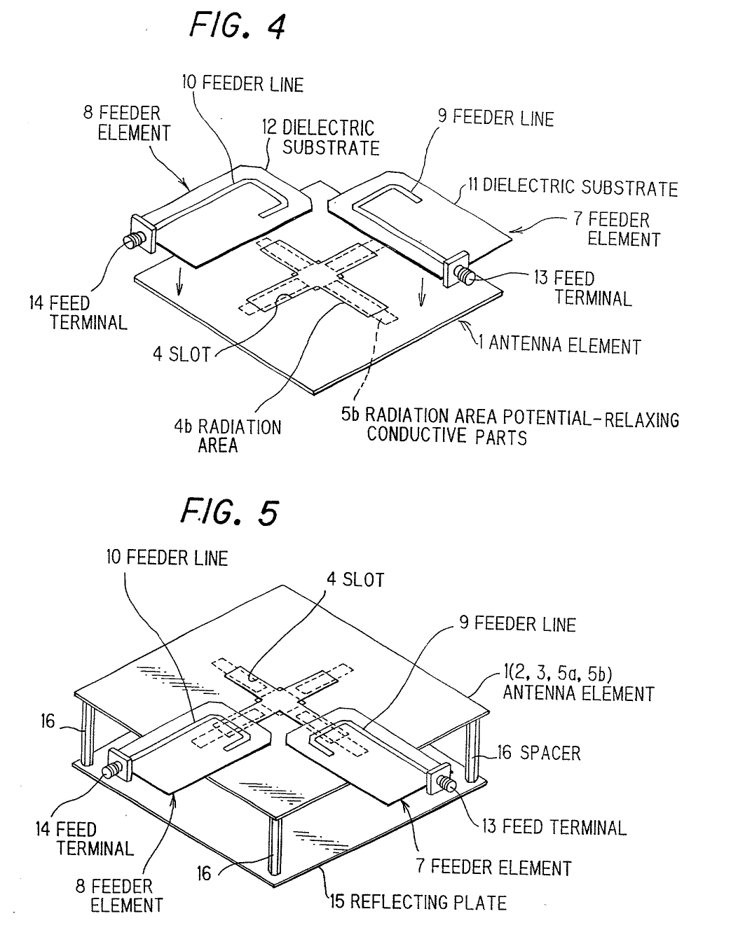

FIG. 3 is an elevational view showing an antenna apparatus in which a feeder line is attached to the antenna element shown in FIG. 1, and FIG. 4 is an exploded perspective view of the antenna apparatus shown in FIG. 3.

In this antenna apparatus, two feed elements 7, 8 are attached on the adjacent two radiation areas 4b of the slot 4 on the conductive plate 3 of the antenna element 1. The feed element 7 comprises a dielectric substrate 11, a feeder line 9 formed on the dielectric substrate 11 and consisting of a conductor, and a feed terminal 13 electrically connected to the feeder line 9. The feed element 8 comprises, similarly, a dielectric substrate 12, a feeder line 10 and a feed terminal 14.

The feeder lines 9, 10 are constituted by using a printed circuit board in which a conductive plate (foil) such as a copper plate or an aluminum plate is formed on one face of the dielectric substrate 11 (12) (the upper face in the figure), leaving the feeder line 9 (10) by a method of etching the conductive plate, etc., attaching the feed terminal 13 (14) to the end portion of the printed circuit board, and connecting it to the feeder line 9 (10).

The feed element 7 (8) is constructed such that the feeder line 9 (10) is attached so as to cross the radiation area 4b of the slot 4, and high frequency power source (not shown) is fed from the feed terminal 13 (14).

According to such an antenna apparatus, since the slot 4 has a cross shape obtained by making two straight-line slots cross each other, electromagnetic wave vibrating in the longitudinal direction (for example, vertical polarization) and electromagnetic wave vibrating in the lateral direction (for example, horizontal polarization) can be radiated. This antenna apparatus functions so that the crossing area potential-relaxing conductive part 5a and the radiation area potential-relaxing conductive parts 5b suppress the occurrence of cross-polarization components, and hence the main radio components can be efficiently radiated.

The antenna element 1 in this antenna apparatus radiates radio waves symmetrically in the one face direction (hereinafter referred to as “forward”) and in the other face direction (hereinafter referred to as “rearward”) of the dielectric substrate 2. When this radio wave has a single directional pattern radiated only in the forward direction, the antenna apparatus may have a construction that a reflecting plate is provided rearward.

FIG. 5 is a appearance perspective view showing the appearance in another embodiment of the antenna apparatus of the present invention.

The different point from the antenna apparatus shown in FIG. 3 is that the radio wave is radiated only in the forward direction.

In the antenna apparatus shown in FIG. 5, a reflecting plate 15 consisting of a conductor is provided in parallel to the antenna apparatus via spacers 16 at the rear of the antenna apparatus shown in FIG. 3, so as to cover the antenna apparatus.

According to this antenna apparatus, since the radio wave radiated from the antenna element 1 is reflected at the rear, the radio wave can be radiated forward efficiently.

In order to enlarge the band property of the radio wave radiated from this antenna apparatus, it is desired to provide a non-feeding element as the electric characteristics adjusting plate, on one face direction of the antenna element.

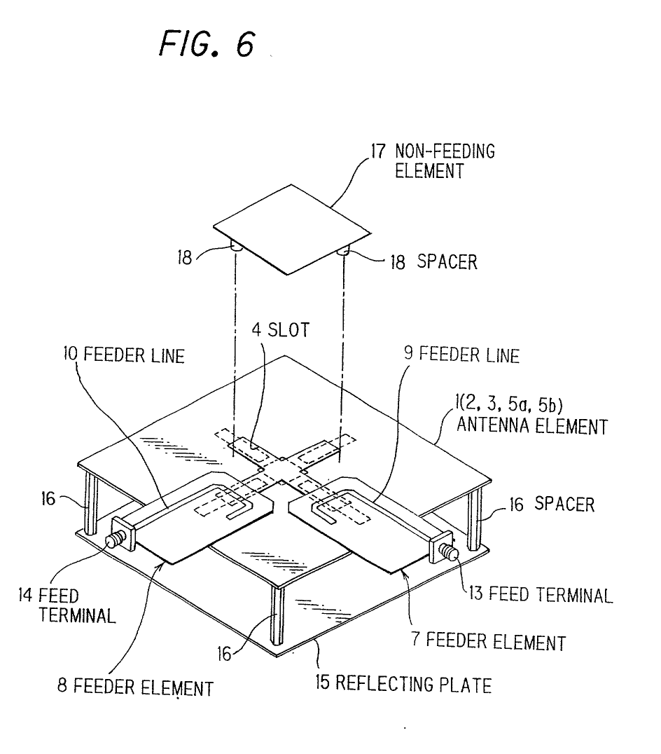

FIG. 6 is an exploded perspective view showing another embodiment of the antenna apparatus of the present invention.

The different point from the antenna apparatus shown in FIG. 5 is that the non-feeding element is provided on one face of the dielectric.

This antenna apparatus has a construction that a non-feeding element 17 as the electric characteristics adjusting plate is provided so as to face the slot 4 with a predetermined space, at the front of the antenna apparatus shown in FIG. 5. This non-feeding element 17 is formed of a conductive plate, and attached at a position where it can work for relieving the frequency characteristics, at the front of the antenna element 1 by spacers 18.

According to this antenna apparatus, the radio wave from the antenna element 1 is radiated forward with directivity, the radio wave can be radiated efficiently with a broadband property by means of the non-feeding element 17.

Here, an antenna apparatus in a ground station in the mobile phone system is constituted by arranging a plurality of antenna elements in a line in the perpendicular direction in order to enhance the transmission and reception ability.

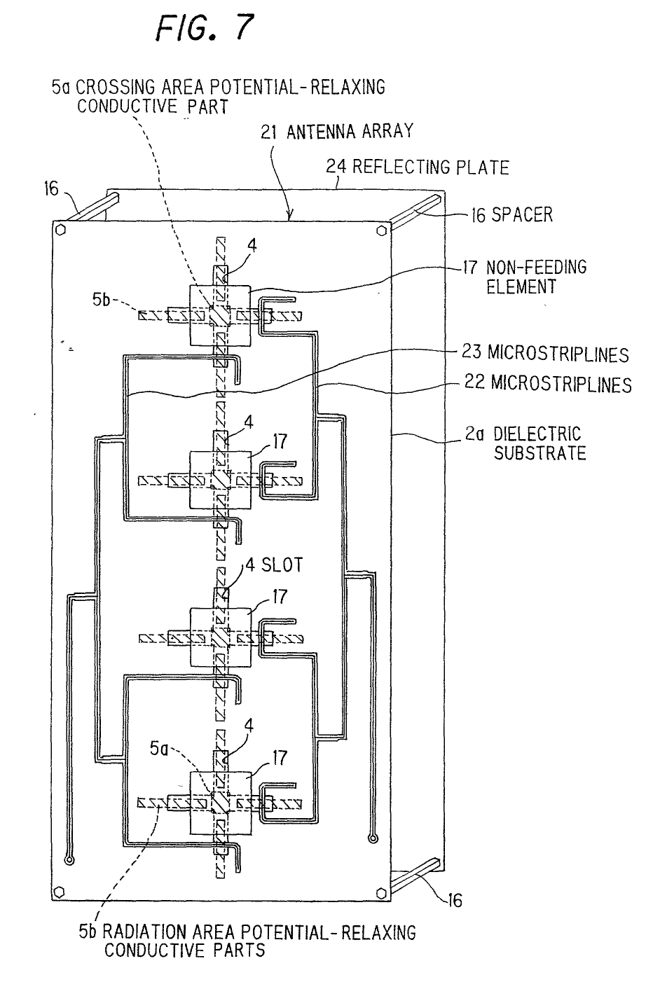

FIG. 7 is a perspective view showing the appearance in another embodiment of the antenna apparatus of the present invention.

In this antenna apparatus, a plurality of cross-shaped slots 4 is formed in the longitudinal direction on a rectangular dielectric substrate 2a having a size for a plurality of antenna elements (four in the figure, but the number is not limited thereto), and a crossing area relieving conductive plate 5a and a radiation area potential-relaxing conductive parts 5b are attached thereto corresponding to each slot 4, to thereby form a antenna array 21. Power is fed in parallel by microstriplines 22, 23 formed by etching a conductive plate adhered to one face of the dielectric substrate 2a. A reflecting plate 24 is provided at the rear of this antenna array 21, and non-feeding elements 17 are attached at the front of each slot 4, respectively.

By arranging such a antenna array 21 perpendicularly, an antenna apparatus having a property obtained by arranging a plurality of antenna elements perpendicularly can be obtained with a simple construction.

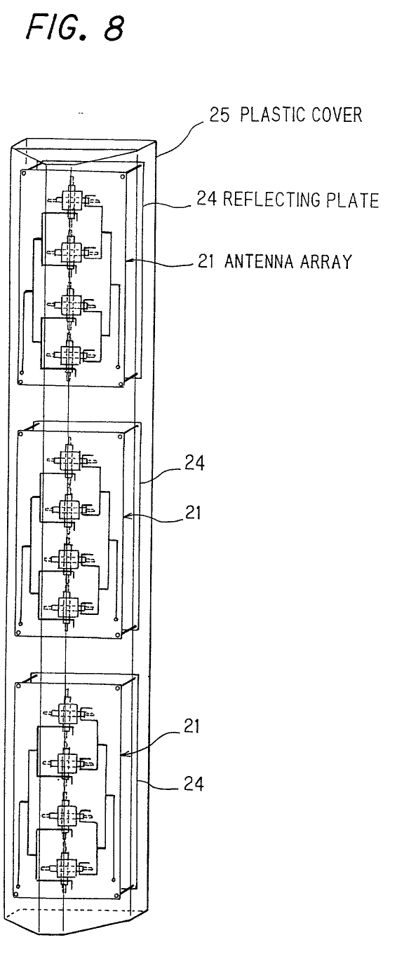

FIG. 8 is a perspective view showing the appearance of a modified embodiment of the antenna apparatus of the present invention.

With this antenna apparatus, a multiple-string longitudinal antenna apparatus is formed by arranging the antenna array 21 shown in FIG. 7 in plural stages (three stages in the figure, but the number of stages is not limited thereto) in the perpendicular direction, and covering these with a plastic cover 25.

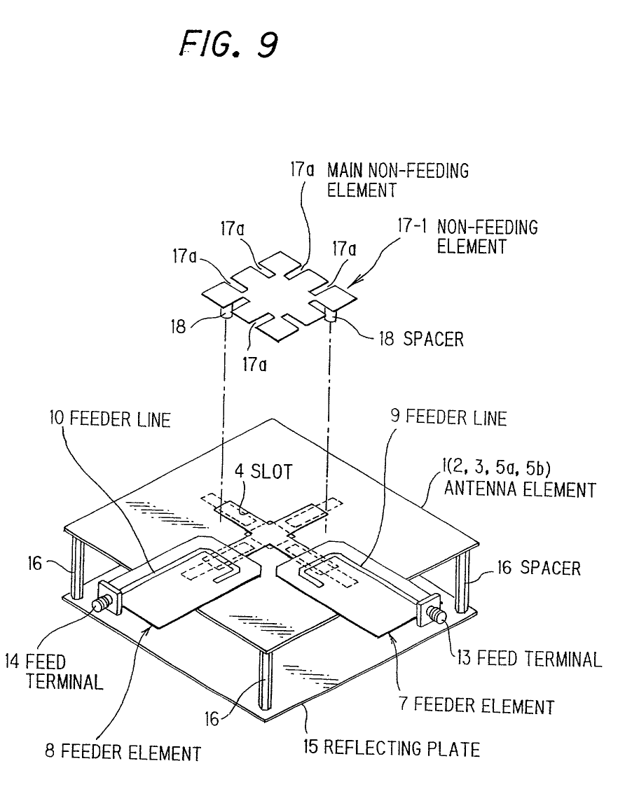

FIG. 9 to FIG. 15 are exploded perspective views showing modified embodiments of the antenna apparatus of the present invention. That is to say, in the antenna apparatus shown in FIG. 9 to FIG. 15, by changing the shape of the non-feeding element in the antenna apparatus shown in FIG. 6, the impedance is adjusted, to thereby change the frequency characteristics.

With the modified embodiment shown in FIG. 9, the impedance is adjusted by a non-feeding element 17-1 in which a plurality of notches 17a (four in the figure, but the number of notches is not limited thereto) is formed at the edge on the outer periphery of the conductive plate, to thereby change the radio property.

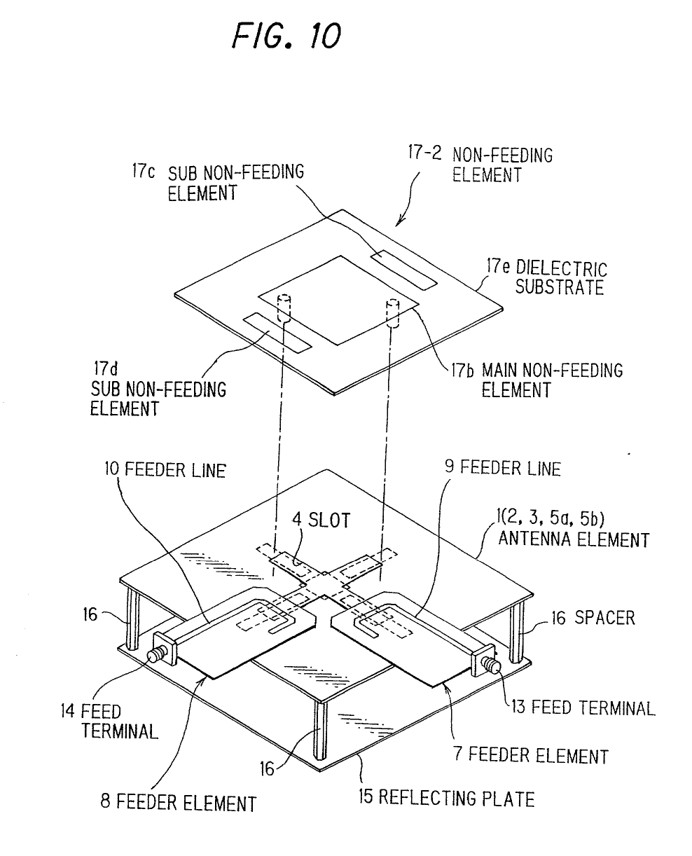

With the modified embodiment shown in FIG. 10, a non-feeding element 17-2 comprises a dielectric substrate 17e, a main non-feeding element 17b attached at the center of the dielectric substrate 17e, and sub non-feeding elements 17c, 17d attached on the both sides of the main non-feeding element 17b. The impedance is adjusted by the main non-feeding element 17b and the sub non-feeding elements 17c, 17d, to thereby change the radio property.

The main non-feeding element 17b and the sub non-feeding elements 17c, 17d are formed by etching a dielectric substrate having a conductive plate adhered on one face thereof.

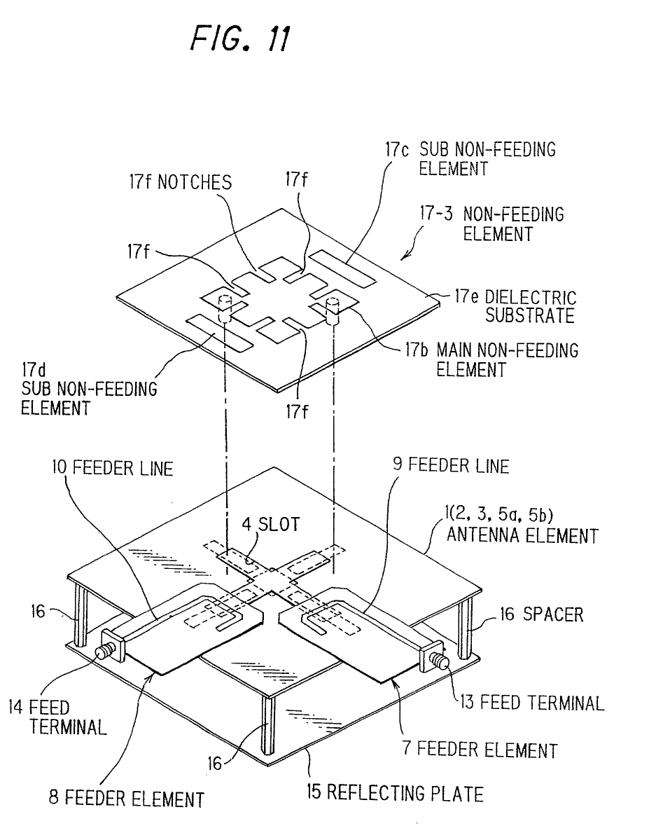

With the modified embodiment shown in FIG. 11, by using a non-feeding element 17-3 in which notches 17f are formed at the outer margin of the main non-feeding element 17b in the center of the non-feeding element 17-2 in the modified embodiment shown in FIG. 10, the impedance is adjusted by the notches 17f in the main non-feeding element 17b and a sub non-feeding element 17d, to thereby change the radio property.

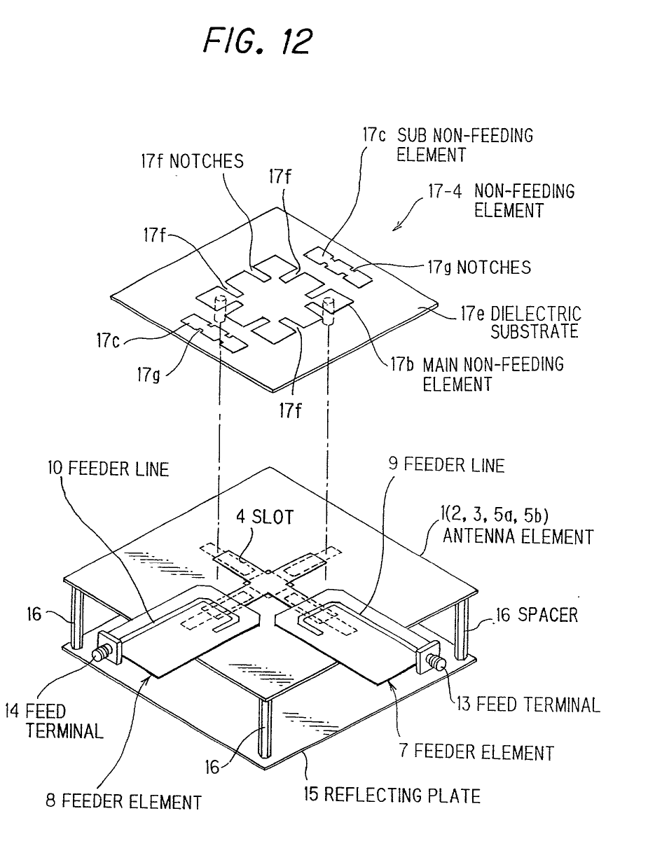

With the modified embodiment shown in FIG. 12, by using a non-feeding element 17-4 in which notches 17g are formed at the edge on the main non-feeding element side of the sub non-feeding element 17c and at the opposite edge thereof in the non-feeding element 17-3 in the modified embodiment shown in FIG. 11, the impedance is adjusted to thereby change the radio property.

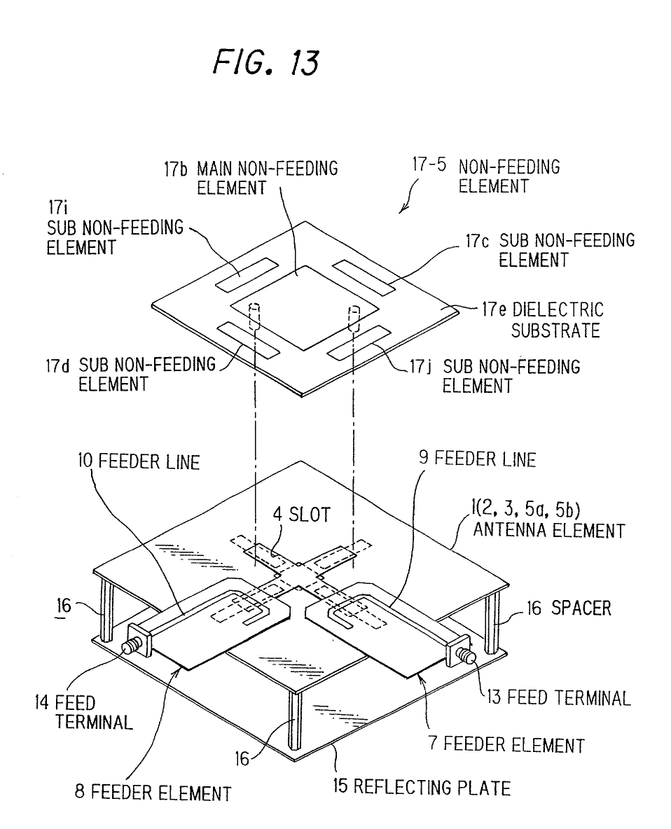

With the modified embodiment shown in FIG. 13, by using a non-feeding element 17-5 in which sub non-feeding elements 17c, 17d, 17i and 17j are attached in parallel to the four sides of a main non-feeding element 17a on a dielectric substrate 17e, the impedance is adjusted to thereby change the radio property. These sub non-feeding elements 17c, 17d, 17i and 17j are formed by etching a conductive plate of the dielectric substrate, with the conductive plate being adhered on one face thereof.

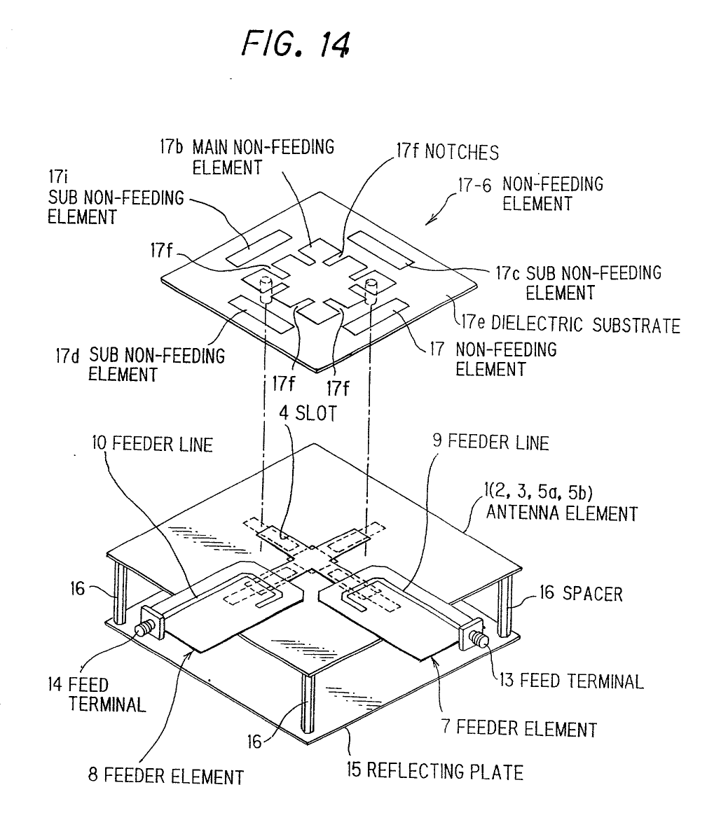

With the modified embodiment shown in FIG. 14, by using a non-feeding element 17-6 in which notches 17f are formed at each margin of the main non-feeding element 17b located at the center of the non-feeding element 17-5 in the modified embodiment shown in FIG. 13, the impedance is adjusted by these notches 17f and the sub non-feeding elements 17c, 17d, 17i and 17j to thereby change the radio property.

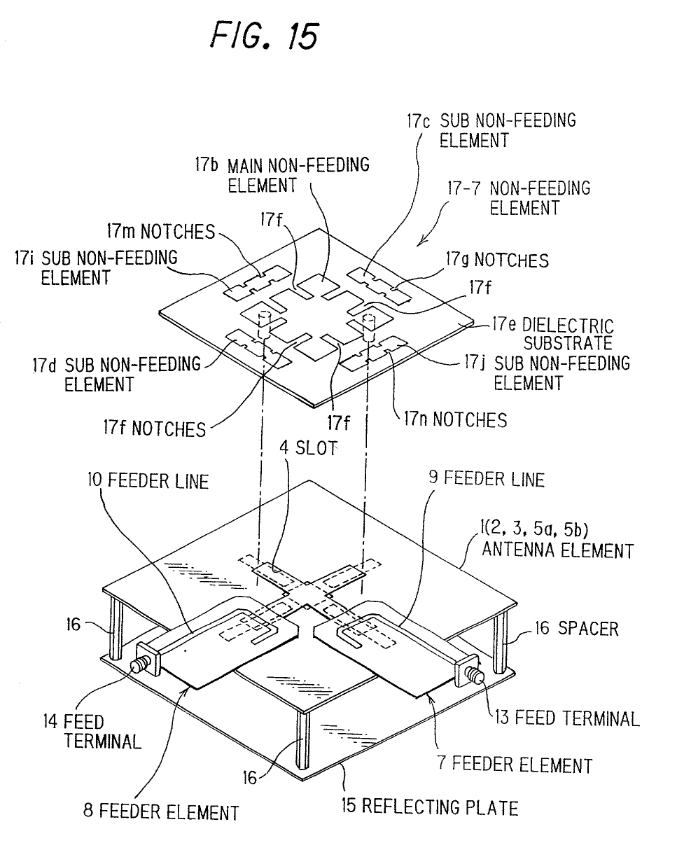

With the modified embodiment shown in FIG. 15, by using a non-feeding element 17-7 in which notches 17g, 17h, 17m, 17n are formed in each sub non-feeding element 17c, 17d, 17i, 17j in the non-feeding element 17-6 in the modified embodiment shown in FIG. 14, the impedance is adjusted to thereby change the radio property.

In the embodiments and modified embodiments described above, the description has been given of a case where a radiation area potential-relaxing conductive parts is attached on the backside of the radiation area of the cross-shaped slot on the other face of the dielectric substrate, but the present invention is not limited thereto, and the radiation area of the slot, the crossing area potential-relaxing conductive part and the radiation area potential-relaxing conductive parts may be formed on the same plane by rotating these by 45 degrees.

Moreover, in the embodiments, the description has been given of a case where a microstriplines is used for the feeder line, but the present invention is not limited to this case, and the antenna structure may be simplified by using a coplanar line.

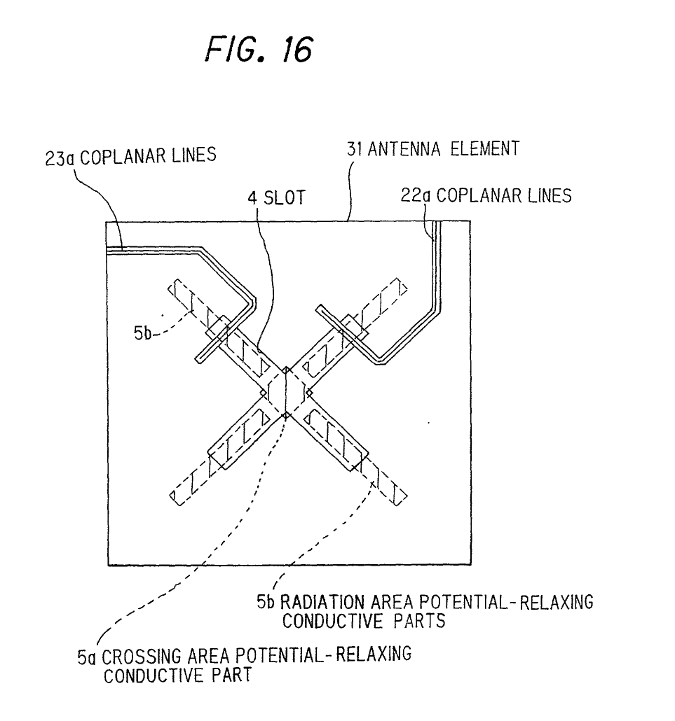

FIG. 16 is an elevational view showing another embodiment of the antenna element of the present invention.

This antenna element 31 is constituted such that a slot 4, a a crossing are a potential-relaxing conductive part 5a and a radiation area potential-relaxing conductive parts 5b are rotated by 45 degrees on the same plane, and power is fed by coplanar lines 22a and 23a.

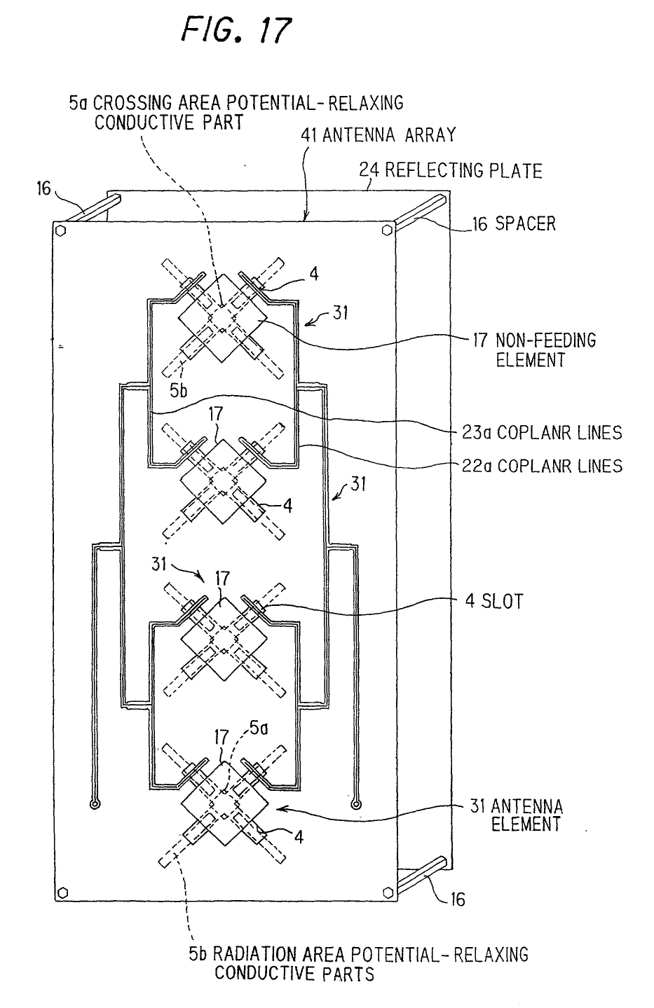

FIG. 17 is a perspective view showing the appearance in another embodiment of the antenna element of the present invention.

This antenna element 41 is constituted such that the antenna element 31 shown in FIG. 16 are formed in plural numbers (four in the figure, but the number is not limited thereto) in one line (in the longitudinal direction in the figure) on one dielectric substrate 2. By forming a crossing area potential-relaxing conductive part 5a and a radiation area potential-relaxing conductive parts 5b, corresponding to each slot 4 of these antenna element 31, a composite antenna array 41 is formed. Power is fed in parallel to each slot 4 of the composite antenna array 41 by coplanar lines 22a, 23a. A reflecting plate 24 is provided at the rear (on the right side in the figure) of the composite antenna array 41, and a non-feeding element 17 is provided at the front of each slot 4 (on the left side in the figure), respectively.

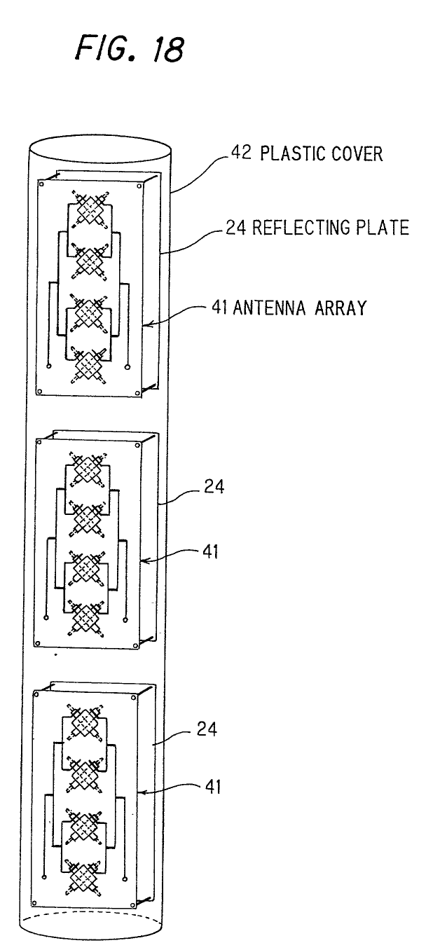

FIG. 18 is a perspective view showing the appearance in another embodiment of the antenna apparatus of the present invention.

The antenna apparatus shown in this figure is a multiple-string antenna apparatus formed by arranging the antenna array 41 shown in FIG. 17 in plural stages (three stages in the figure, but the number of stages is not limited thereto) in the perpendicular direction, and covering these with a plastic cover 42.

What is claimed is:

1. An antenna apparatus in which an antenna element comprising a conductive plate having a slot formed thereon is attached to a dielectric substrate, wherein said antenna element comprises: a conductive plate attached to one face of said dielectric substrate and having a cross-shaped slot formed thereon; a crossing area potential-relaxing conductive part attached at the position of a crossing of said cross-shaped slot on the other face of said dielectric substrate; and a strip-shaped radiation area potential-relaxing conductive parts attached at the position of a radiation area of said cross-shaped slot on the other face of said dielectric substrate.

2. An antenna apparatus in which an antenna element comprising a conductive plate having a slot formed thereon is attached to a dielectric substrate, wherein said antenna element comprises: a conductive plate attached to one face of said dielectric substrate and having a plurality of cross-shaped slots formed thereon; a crossing area potential-relaxing conductive part attached at the position of each crossing of each cross-shaped slot on the other face of said dielectric substrate; and a strip-shaped radiation area potential-relaxing conductive parts attached at the position of each radiation area of each cross-shaped slot on the other face of said dielectric substrate.

3. An antenna apparatus according to either one of claim 1 or claim 2, wherein a reflecting plate consisting of a conductor is provided on the other face of said dielectric substrate, via spacers in parallel thereto, so as to cover said dielectric substrate.

4. An antenna apparatus according to either one of claim 1 to claim 3, wherein an electric characteristics adjusting plate consisting of a conductor is provided on one face of said dielectric substrate, via spacers in parallel to said dielectric, so as to cover a central portion of each cross-shaped slot.

5. An antenna apparatus according to claim 4, wherein a notch is formed on said electric characteristics adjusting plate.

6. An antenna apparatus according to either one of claim 4 or claim 5, wherein said electric characteristics adjusting plate comprises another dielectric substrate, a main non-feeding element attached on said other dielectric substrate, and a plurality of strip-shaped sub non-feeding elements attached in parallel to an opposing side of said main non-feeding element on said other dielectric substrate.

7. An antenna apparatus according to claim 6, wherein a notch is formed on at least either one of said main non-feeding element or said sub non-feeding element.

8. An antenna apparatus according to either one of claim 2 to claim 7, wherein power is fed in parallel to the radiation area of each slot.
